(19) United States
(12) Patent Application Publication
(10) Pub. No.: US 2010/0117469 A1
(43) Pub. Date: May 13, 2010

(54) ELECTRIC MOTOR

(76) Inventors: Armin Niederer, Karlsruhe (DE); Linh-Thao Stubenbord, Buehl (DE); Tobias Kuechen, Emmendingen (DE)

Correspondence Address: MICHAEL J. STRIKER, 103 EAST NECK ROAD, HUNTINGTON, NY, 11743, US

(21) Appl. No.: 12/596,207

(22) PCT Filed: Mar. 20, 2008
(86) PCT No.: PCT/EP08/53400

§ 371 Date: Oct. 16, 2009

(30) Foreign Application Priority Data
Apr. 25, 2007 (DE) 10 2007 019 431.7

(51) Int. Cl. H02K 11/00

(52) U.S. Cl. 310/71

(57) ABSTRACT

The invention relates to an electromotor (1) having a conducting rotor shaft (3), a contacting element (10) for electrically contacting the rotor shaft (3), and a connection device (14) for connecting the rotor shaft to a virtual or fixed potential.

The present invention relates to an electric motor that includes, in particular, a system for eliminating EMC interference.

The commutating system of DC motors typically includes a commutator and brushes. The brushes run on the commutator surface, along the “commutator bars”, thereby enabling a contacting of coil windings installed on the rotor. When a brush leaves a commutator bar due to the rotation of the rotor, a switching procedure takes place, which is called commutation. This may result in gas discharges accompanied by very steep current rises which result in high-frequency noise radiation.

Interference is typically eliminated from an electric motor via an interference suppressor filter which may include interference suppression capacitors and/or interference suppression inductors, depending on the requirement. When interference suppression capacitors are used, they are connected between the supply voltage lines or between a star point and the supply voltage lines. In addition, varistors may be used to limit the motor shut-off pulse.

Despite interference suppression measures of this type, it is not possible to completely eliminate the electromagnetic radiation from an electric motor. The object of the present invention, therefore, is to provide an electric motor, in the case of which a considerable improvement of the interference suppression damping may be attained for high frequencies in particular.

This object is achieved by the electric motor according to claim 1.

Further advantageous embodiments of the present invention are described in the dependent claims.

According to one aspect, an electric motor is provided. The electric motor includes a conductive rotor shaft, a contacting element for electrically contacting the rotor shaft, and a connecting device for connecting the rotor shaft to a virtual or fixed potential.

One idea behind the present invention is to electrically couple the rotor shaft to a virtual or predefined fixed potential, in particular a supply potential. This results in greatly reduced noise radiation in the high frequency range as compared to an electric motor that includes an electrically floating rotor shaft.

Furthermore, the contacting element may include a bearing, in particular a spherical cap. Furthermore, the contacting element may be retained on a carrier element, in particular a printed circuit board.

According to a further embodiment, a contact point may be situated on the carrier element in order to provide the virtual or fixed potential.

It may be provided that the contact point is electrically coupled to a supply voltage potential and/or to a further motor element, in particular to at least one part of the motor housing.

Furthermore, the contact point may be electrically connected to a conductor region that is squarely situated on the carrier element, and that is used as a ground surface.

According to one embodiment, one or more capacitive components and/or one or more inductive components are provided, on the carrier element in particular, in order to connect the contacting element to one or more fixed potentials, in particular supply voltage potentials.

Preferred embodiments of the present invention are explained below in greater detail with reference to the attached drawings.

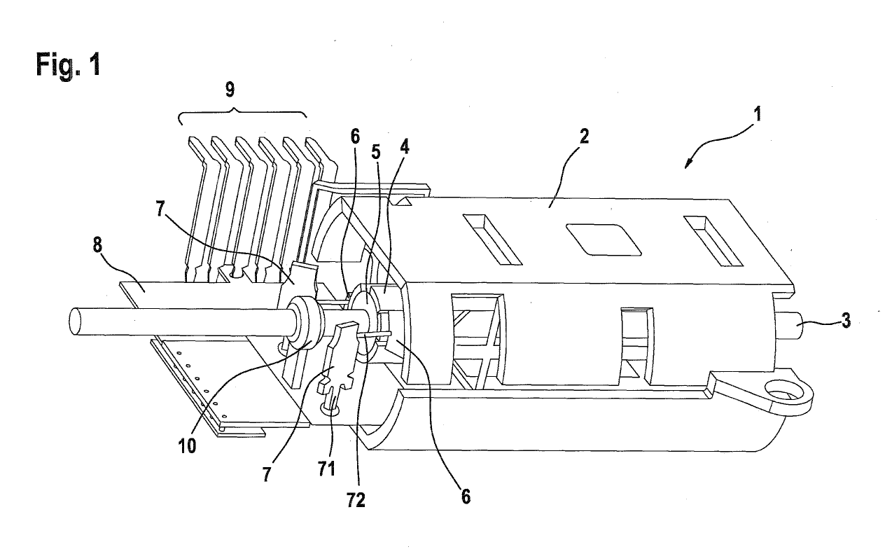

FIG. 1 shows a perspective illustration of an electric motor according to one embodiment of the present invention;

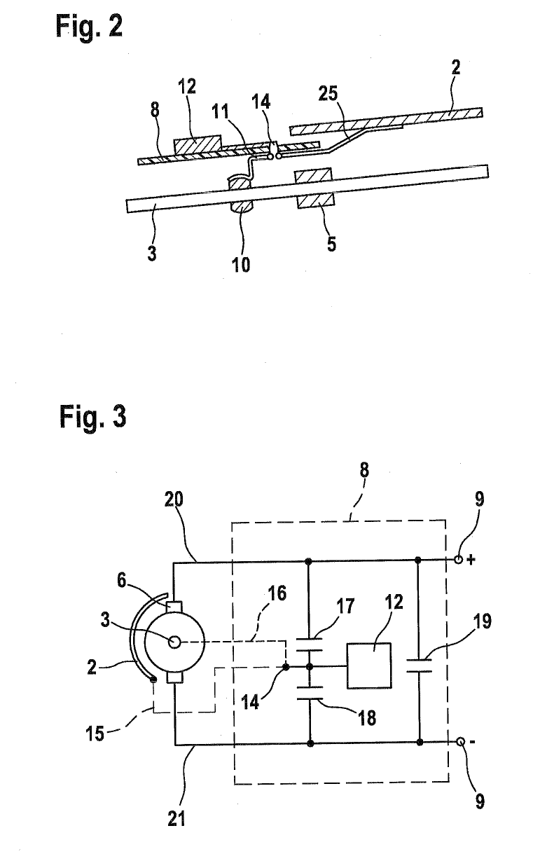

FIG. 2 shows a cross-sectional illustration to indicate the contacting of the rotor shaft to a star point;

FIG. 3 shows a wiring diagram, to illustrate the interference suppression of the electric motor in FIG. 1.

FIG. 1 shows a perspective illustration of an electric motor 1 with a motor housing 2 which is composed of two motor half-shells in the embodiment shown. A rotor shaft 3 extends along a center axis of motor housing 2 and includes several rotor coils (they are hidden by motor housing 2) which are electrically contactable via commutator bars 4 of a commutator 5. Pole magnets (not shown) are situated on an inner surface of motor housing 2 in a manner such that they are essentially opposite to the stator coils.

The commutator bars of commutator 5 are contacted via two brushes 6 which are located on motor housing 2, and which are pressed against commutator 5, e.g., using a spring element, in order to attain a reliable electrical contacting between particular commutator bar 4 and corresponding brush 6. Brushes 6 are connected to a printed circuit board 8 via a particular connecting element 7.

In the embodiment shown, connecting elements 7 are designed as soldering pins 71 which are connected to brushes 6 via a suitable wire section 72. Printed circuit board 8 includes connection contacts 9 on the side (in a direction perpendicular to the rotor shaft), via which electric motor 1 may be contacted externally. Printed circuit board 8 includes interference suppression elements, such as interference suppression capacitors, interference suppression inductors, or the like. It is also possible to provide another suitable carrier element in place of printed circuit board 8.

Rotor shaft 3 is supported via a spherical cap 10 which is electrically connected to a contact point 14 on printed circuit board 8 via a contacting 11 (see FIG. 2). Rotor shaft 3 and spherical cap 10 are made of a conductive material. Rotor shaft 3 is preferably formed of metal to ensure adequate stability. Spherical cap 10 may preferably be made of a metal, a conductive plastic, a conductive ceramic, or the like, so that rotor shaft 3 may be electrically contacted. In this manner, rotor shaft 3 may be connected via spherical cap 10 either directly or via a suitable interference suppression element to a virtual potential, such as a star point, to which a further motor part such as motor housing 2 is connected, or to a fixed potential, e.g., to one of the supply voltage potentials.

In the section of electric motor 1 shown in FIG. 2, rotor shaft 3 is connected via spherical cap 10 to contact point 14 on printed circuit board 8, thereby making it possible to increase the damping of high frequency interfering signals, in particular starting at frequencies of 30 MHz. Furthermore, motor housing 2 is connected to contact point 14 via a connecting element 25 which may be made of sheet metal, for example. To simplify the installation of printed circuit board 8 in the motor housing, connecting element 25 may be designed to be elastic, and, in the installed state, it may press against the inside of motor housing 8 in order to electrically contact it.

The cause of the increase in damping due to the contacting of rotor shaft 3 may be explained via two effects. Firstly, the high-frequency interference currents are diverted to a virtual, broad-area, voluminous ground potential, such as that formed, e.g., by motor housing 2 which is also connected to contact point 14. Secondly, the contacting via spherical cap 10 induces a change in the effective antenna length and, therefore, the noise radiation and interference that acts on the adjacent conductor tracks on printed circuit board 8.

As an alternative or in addition to the connection of spherical cap 10 to motor housing 2, it is possible for the star point formed by contact point 14 to be connected via one or more capacitors to one or more supply voltage potentials which are provided via connection contacts 9.

Printed circuit board 8 may include shielding layers to protect the connecting lines contained therein. A shielding layer may be designed as ground surface 12 which is situated squarely on printed circuit board 8 and is electrically connected via a suitable connection to contact point 14. Contact point 14 may be located inside ground surface 12. Furthermore, the connections to motor housing 2, rotor shaft 3, and to the related first and second capacitors may be realized via various points on ground surface 14.

FIG. 3 shows a wiring diagram for coupling rotor shaft 3 according to a preferred embodiment. The figure shows a first and second supply voltage line 20, 21 which connect the respective external connection contacts 9 via connecting element 7 to brushes 6. Supply voltage lines 20, 21 extend across printed circuit board 8 which is indicated in FIG. 3 using a dashed line. Contact point 14 is used as the star point which is connected to motor housing 2 via a connection (shown as a dashed line) 15 having low impedance.

Furthermore, rotor shaft 3 is connected to contact point 14 as the star point, via connection line 16 which is also designed to have low impedance. Contact point 14 is connected to first voltage supply line 20 via a first capacitor 17, and it is connected to second voltage supply line 21 via a second capacitor 18. To provide additional interference suppression, a third capacitor 19 may be connected between first and second voltage supply lines 20, 21. In addition or as an alternative to third capacitor 19, an inductor in first and/or second voltage supply line 20, 21 may be connected in series with the motor.

According to the present invention, it is provided that rotor shaft 3 is connected to an at least virtual potential which is formed by a further conductive motor element that is not connected to a fixed potential. It is sufficient, however, to implement one of the measures described below in order to reduce the noise radiation in the high-frequency range:
1. Conductively connect rotor shaft 3 to a further conductive element—which is not connected to a fixed potential—of electric motor 1, in particular to motor housing 2;
2. connect rotor shaft 3 via a capacitor to first supply voltage line 20; and
3. connect rotor shaft 3 via a capacitor to second supply voltage line 21.

As an alternative, rotor shaft 3 may also be connected via an inductor to the first or second supply voltage line.

The contacting of rotor shaft 3 need not necessarily take place via its bearing. Rotor shaft 3 may also be provided with a further contacting that is independent of its bearing, and that enables electrical contacting of rotor shaft 3 to be realized.

By connecting rotor shaft 3 to at least one virtual potential, it is possible to dampen high-frequency disturbing currents to a considerable extent. Furthermore, when the rotor shaft is contacted to ground, the effective antenna length for the electromagnetic noise radiation may be changed, so that the electromagnetic radiation may be reduced, thereby reducing the interference that acts on adjacent conductor tracks on the printed circuit board.

What is claimed is:

1. An electric motor (1), comprising:
a conductive rotor shaft (3);
a contacting element (10) for electrically contacting the rotor shaft,
a connecting device (14) which is used to connect the rotor shaft (3) to a virtual or fixed potential.

2. The electric motor as recited in claim 1, in which the contacting element includes a bearing, in particular a spherical cap (10).

3. The electric motor as recited in claim 1, in which the contacting element is held on a carrier element (8), in particular a printed circuit board.

4. The electric motor as recited in claim 3, in which a contact point (14) is located on the carrier element (8) in order to provide the virtual or fixed potential.

5. The electric motor as recited in claim 4, in which the contact point (14) is electrically coupled to a supply voltage potential and/or to a further motor element, in particular to at least one part of the motor housing (2).

6. The electric motor as recited in claim 4, in which the contact point (14) is electrically connected to a conductor region that is situated on the carrier element (8), squarely in particular, the conductor region being used as a ground surface for providing the virtual or fixed potential.

7. The electric motor as recited in claim 1, in which one or more capacitive components (17, 18, 19) and/or one or more inductive components are provided, on the carrier element (8) in particular, in order to connect the contacting element to one or more fixed potentials, in particular supply voltage potentials.
